(19) United States
(12) Patent Application Publication
(10) Pub. No.: US 2011/0225833 A1
(43) Pub. Date: Sep. 22, 2011

(54) Razor Blade Protection System

(76) Inventor: Jeffrey A. Hoffman, Marquette, MI (US)

(21) Appl. No.: 12/726,331

(22) Filed: Mar. 17, 2010

(51) Int. Cl. B26B 21/40

(52) U.S. Cl. 30/538; 30/540

(57) ABSTRACT

A razor blade protection system includes a body having a top portion and a bottom portion between which the head of a razor blade may be secured, the top portion and bottom portion are biased such that the bias force must be overcome to insert the razor blade between the top portion and bottom portion. A protective material is located within the body such that, when a razor blade is secured between the top portion and bottom portion, the compressive biasing force maintains the protective material in continuous contact with the cutting edge of the razor blade. The protective material may be saturated with a corrosion inhibiting liquid.

### CROSS-REFERENCE TO RELATED APPLICATIONS

This application incorporates by reference and claims priority to U.S. Provisional Patent Application No. 61/201,490 filed Mar. 18, 2009.

### BACKGROUND OF THE INVENTION

The present subject matter relates generally to a razor blade protection system. More specifically, the present invention relates to a razor blade protection system including a biasing mechanism that exerts a force to compress the head of the razor between opposing surfaces.

Disposable razors have relatively short life spans due to corrosion on the razor's edges. The razor's edges are dulled by the corrosive effects of the water and minerals in contact with the razor during storage. There have been numerous approaches taken in an attempt to extend the life of razors. For example, U.S. Patent Publication No. 2005/0189338 A1 describes drying the razor immediately after use as a means to increase the razor's lifetime. Alternatively, numerous patents describe fully immersing the razor in a reservoir of rust inhibiting liquid, such as mineral oil, after use. Two examples of using reservoirs of corrosion inhibiting liquids are provided in U.S. Pat. Nos. 6,634,492 and 5,007,533. Another known technique is to press the razor into an absorbent material saturated with a corrosion inhibiting liquid as outlined in U.S. Pat. No. 5,319,852. In another example, U.S. Patent Publication No. 2007/0193042 A1 discloses using a dissimilar metal, such as aluminum, as a sacrificial anode to protect the steel razor blade.

While the referenced known methods may be used to protect and lengthen the useful life of a shaving razor, the known techniques all exhibit one or more of the following disadvantages: (1) inventions relying on reservoirs of protective liquid are bulky making them inconvenient to store; (2) inventions relying on a reservoir of protective liquid create a risk of leaks; (3) bulky fluid filled devices are difficult to use when traveling, especially air travel where they are often not permissible; (4) for those devices using an absorbent material saturated with a protective oil, without a constant load applied between the razor head and the absorbent material, air gaps will form between the absorbent material and the razor head as the absorbent material subsides over time, which minimizes the effect of the corrosion-inhibiting liquid; (5) many of the known techniques and devices require significant amounts of material to fabricate; (6) using a sacrificial anode may work when the entire cutting edge and sacrificial anode are fully immersed in a continuous pool of water and minerals, but if sections of the blade are exposed to water and yet isolated from the protective anodic bands, corrosion will occur on the stainless steel cutting edges.

As shown, no known solution provides a small, portable, effective device for extending the life of a razor blade. Accordingly, a need exists for a convenient functional razor blade protection system as described and claimed herein.

### BRIEF SUMMARY OF THE INVENTION

The subject matter presented herein provides a solution to the problems presented by the existing known devices. The razor blade protection system described and claimed herein provides a protective material, such as an absorbent foam element saturated with corrosion inhibiting material, applied to the razor blade's cutting edge or edges using a constant force throughout its storage. When saturated with the protectant fluid, the absorbent foam displaces water from the cutting edges and replaces the water with corrosion inhibiting fluid diminishing corrosion along the cutting edges. Because the foam is held against the cutting edges under a constant force, the effects of subsiding or deforming foam are minimized.

In one embodiment, a razor blade protection system includes a body having a top portion and a bottom portion between which the head of a razor blade may be secured, the top portion and bottom portion are biased such that the bias force must be overcome to insert the razor blade between the top portion and bottom portion. A protective material is located within the body such that, when a razor blade is secured between the top portion and bottom portion, the compressive biasing force maintains the protective material in continuous contact with the cutting edge of the razor blade.

In another embodiment, a razor blade protection system includes a body including a bottom portion and one or more springs, wherein the body is adapted to be secured to the head of a razor blade. A protective material is located within the body such that, when the body is secured to the head of a razor blade, the one or more springs exert a compressive force to maintain the protective material in continuous contact with the cutting edge of the enclosed razor blade.

In a further embodiment, a razor blade protection system includes a body including a top portion and a bottom portion. The system also includes one or more springs acting to limit the distance between the top portion and the bottom portion. A protective material is located within the body such that, when the head of a razor blade is secured between the top portion and the bottom portion, the one or more springs force the protective material into continuous contact with the cutting edge of the secured razor blade.

An advantage of the razor blade protection system is the system is relatively small and easy to manufacture.

Another advantage of the razor blade protection system is the small size will encourage users to retain the system for storage at home and while traveling, whereas known devices are bulky and often discarded.

A further advantage of the razor blade protection system is the system will not leak during usage in embodiments where there are no liquid reservoirs.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of an example of a razor blade protection system adjacent to a razor blade.

FIG. 2 is a perspective view of the example of a razor blade protection system shown in FIG. 1, wherein the razor blade protection system is applied to the head of a razor blade.

FIG. 3 is a cross-sectional view of the razor blade protection system applied to the head of a razor blade shown in FIG. 2.

FIG. 4 is a perspective view of another example of a razor blade protection system.

FIG. 5 is a perspective view of another example of a razor blade protection system.

FIG. 6 is a perspective view of another example of a razor blade protection system adjacent to a razor blade.

### DETAILED DESCRIPTION OF THE INVENTION

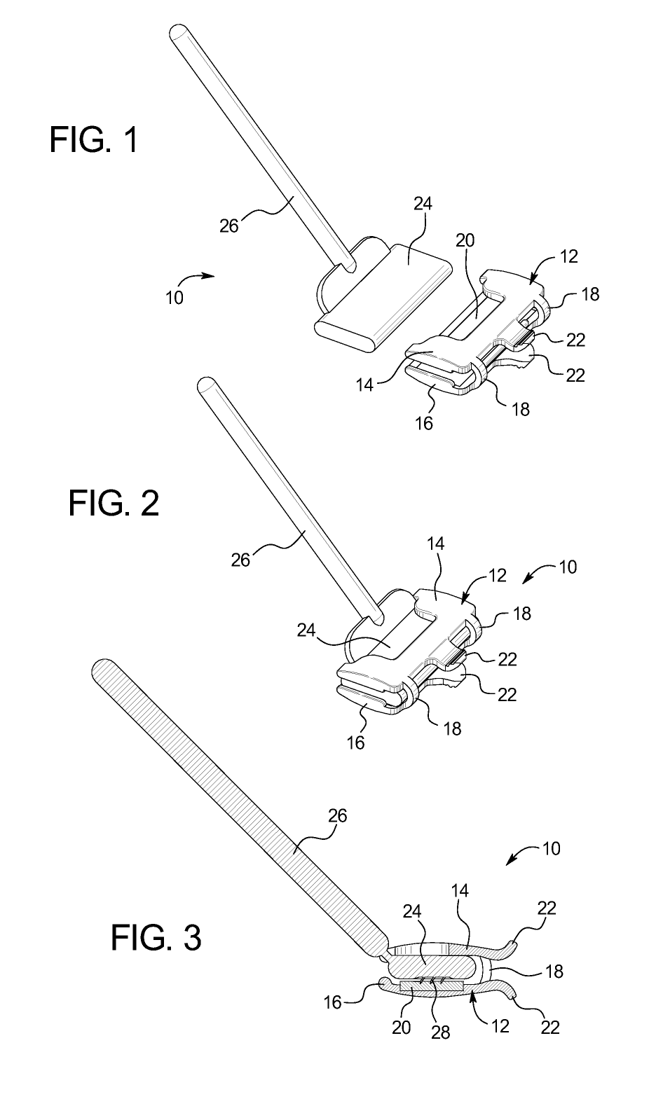

FIG. 1 illustrates an example of a razor blade protection system 10. The embodiment of the razor blade protection system 10 shown in FIG. 1 includes a body 12 including a top portion 14 and a bottom portion 16, a pair of biasing springs 18, a protective material 20 and a pair of levers 22. As shown, the protective material 20 is associated with the bottom portion 16, the protective material 20 faces the top portion 14 and the biasing springs 18 maintain a distance between the protective material 20 and the top portion 14 that is narrower than the depth of a head 24 of a razor blade 26 for which the razor blade protection system 10 is intended to protect. As will be apparent to one of ordinary skill in the art based on the disclosure herein, the dimensions, proportions and shape of the razor blade protection system 10 may be adapted to correspond to a given razor blade 26 and razor blade head 24.

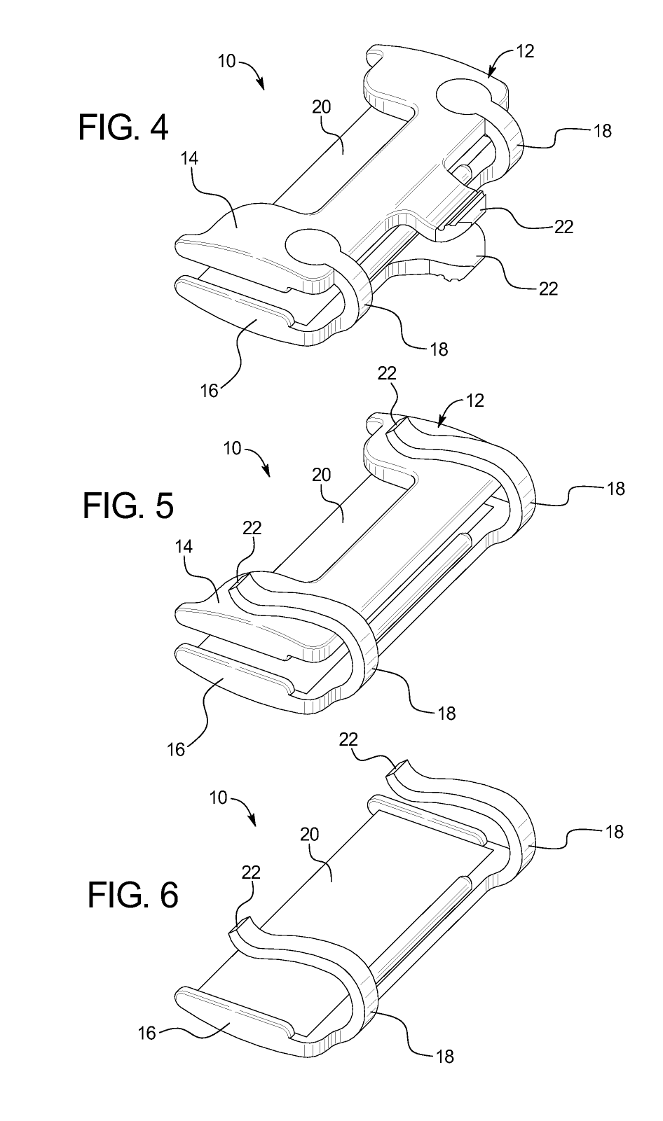

In the example shown in FIG. 1, the razor blade protection system 10 is a unitary injection molded plastic piece. However, it is understood that the razor blade protection system 10 may be formed from a plurality of pieces and/or made from a plurality of materials. For example, in another example, a pair of biasing springs 18 join the top portion 14 and the bottom portion 16 forming a press fit assembly, as shown in FIG. 4. It is contemplated that each of the described elements may be formed from one or more pieces and assembled, welded, adhered, etc. together to form the razor blade protection system 10. It is further understood that the razor blade protection system 10 may include a greater or fewer number of elements. For example, in the embodiment shown in FIG. 6, the razor blade protection system 10 does not include a top portion 14, but rather the biasing springs 18 function to grasp the razor blade head 24 and compress the razor blade head 24 into the protective material 20 located along the bottom portion 16. Similarly, depending on the construction of the protective material 20, it may be possible that the protective material 20 and the bottom portion 16 are a single material. For example, the protective material 20 may be an absorbent material saturated with a corrosion inhibiting fluid and the absorbent material may be treated such that the surface exposed to the razor blade head 24 is porous, but that the remaining surfaces are leak resistant. Alternatively, the protective material 20 may be a more robust structural material that does not require additional support from a bottom portion 16, thus the bottom portion 16 and the protective material 20 may be embodied in a single element.

The top portion 14 shown in FIG. 1 is a U-shaped plastic element generally sized to enclose and protect the razor blade head 24 to which it will be attached. Similarly, the bottom portion 16 shown in FIG. 1 is a generally rectangular plastic element generally sized to protect the razor blade head 24 to which it will be attached. The size, shape, thickness and other configuration of the top portion 14 and the bottom portion 16 will vary depending on the materials used and the configuration of the razor blade head 24. As discussed herein, the biasing springs 18 and/or the protective material 20 may inherently perform the function of the top portion 14 and/or the bottom portion 16, negating the need for separate elements.

As shown in FIG. 1, the top portion 14 and the bottom portion 16 are secured to each other by a pair of biasing springs 18. In the example shown in FIG. 1, the biasing springs 18 are tension springs formed as part of the unitary plastic body 12. However, it is understood that numerous types of biasing springs 18 may be used in the razor blade protection system 10 described herein. For example, by varying the configuration of the razor blade protection system 10 compression springs, torsion springs, or other springs may be used to create the requisite compressive force along the interface of the protective material 20 and the razor blade head 24. As such, the term biasing spring 18 is understood to encompass any material or element that generates the compressive force along the interface of the protective material 20 and the razor blade head 24. It is further understood that although shown as a pair of biasing springs 18 in FIGS. 1-6, there is no minimum or maximum number of springs required to accomplish the goals of the invention described herein.

The razor blade protection system 10 shown in FIG. 1 uses an absorbent material saturated with a corrosion inhibiting liquid as the protective material 20 to be held in contact with the razor blade head 24. The protective material 20 shown in FIG. 1 is open cell foam formed from nitrile butadiene rubber. However, it is understood that the protective material need not be an absorbent material 20 saturated by a corrosion inhibiting liquid. For example, the protective material may be any material that is able to displace the corrosive materials (typically water) from the cutting edge 28 of the razor blade 26 when a compressive force is applied and thereby protect the cutting edge 28 from corrosion, whether or not the protective material is absorbent or saturated with a corrosion inhibiting liquid. When embodied in an absorbent material, the protective material 20 may be any material that absorbs the corrosion inhibiting liquid and releases the corrosion inhibiting liquid when the razor blade head 24 is pressed into the absorbent material 20. Further, in the example shown in FIG. 1, the absorbent material 20 is adhered to the bottom portion 16 with an appropriate adhesive, such as, for example, acrylic adhesive.

As described, in the example shown in FIG. 1, the corrosion inhibiting liquid is mineral oil. However, it is understood that any corrosion inhibiting liquid may be used in the razor blade protection system 10. For example, petroleum jelly may be another example of a corrosion inhibiting liquid. Further it is contemplated that a small reservoir supplying corrosion inhibiting liquid to the protective material 20 could be designed into the body 12 of the razor blade protection system 10, extending the time that may pass between rejuvenating the protective material 20 with corrosion inhibiting liquid.

As shown, the razor blade protection system 10 illustrated in FIG. 1 includes a pair of levers 22 extending from the body 12. The levers 22 are provided to enable a user to apply a force to the razor blade protection system 10 to overcome the bias provided by the biasing springs 18. Accordingly, the levers 22 may be configured and adapted to take any form that enables a user to counteract the bias force. The clam shell design provided in the example illustrated in FIG. 1 has the advantage of being easy to manipulate using one hand, freeing the other hand for holding the razor blade 26. In the example shown in FIG. 5, the levers 22 are the portion of the biasing springs 18 that extend above the top portion 14 of the body 12 (the levers 22 being fused to the body 12 to form a unitary construction). In this example, a user may overcome the bias force by supporting one of the levers 22 with their thumb and squeezing the opposing lever 22 with their index finger causing the levers 22 to pinch together. It is further contemplated that embodiments of the razor blade protection system 10 may not include levers 22. For example, in one contemplated embodiment, the razor blade protection system 10 may be secured in a fixed position and the razor blade 26 may be inserted into the razor blade protection system 10, forcing the razor blade protection system 10 to open and accept the razor blade head 24, enabling one-handed operation.

In use, the protective material 20 is saturated with a corrosion inhibiting liquid. The top portion 14 and the bottom portion 16 are biased by the biasing springs 18 such that the bias force must be overcome to insert the razor blade head 24 between the top portion 14 and the protective material 20 associated with the bottom portion 16. Force is applied to the levers 22 (for example, by pinching the levers 22 between a user's fingers) to overcome the biasing force and insert the razor blade head 24 between the top portion 14 and the protective material 20 in the bottom portion 16. When the force is released and the razor blade head 24 is secured between the top portion 14 and the protective material 20 in the bottom portion 16 as shown in FIGS. 2 and 3, the compressive biasing force provided by the biasing springs 18 maintains the protective material 20 in continuous contact with the cutting edge 28 of the razor blade 26, which displaces any water located along the cutting edge 28 of the razor blade 26 with the corrosion inhibiting liquid, thus protecting the cutting edge 28 of the razor blade 26.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A razor blade protection system comprising:
a body having a top portion and a bottom portion between which the head of a razor blade may be secured, the top portion and bottom portion being biased such that the bias force must be overcome to insert the razor blade between the top portion and bottom portion; and
protective material located within the body such that, when a razor blade is secured between the top portion and bottom portion, the compressive biasing force maintains the protective material in continuous contact with the cutting edge of the razor blade.

2. The razor blade protection system of claim 1, wherein the body is formed from plastic.

3. The razor blade protection system of claim 2, wherein the body is a unitary piece of plastic formed by injection molding.

4. The razor blade protection system of claim 1, wherein the protective material includes open cell foam.

5. The razor blade protection system of claim 4, wherein the open cell foam is formed from nitrile butadiene rubber.

6. The razor blade protection system of claim 4, wherein the open cell foam is saturated with a corrosion inhibiting liquid.

7. The razor blade protection system of claim 6, wherein the corrosion inhibiting liquid is mineral oil.

8. The razor blade protection system of claim 6, further including a reservoir adjacent to the open cell foam.

9. The razor blade protection system of claim 1 further including a pair of levers adapted such that a compressive force applied to the levers counteracts the bias force.

10. The razor blade protection system of claim 9, wherein the pair of levers includes a top lever associated with the top portion and a bottom lever associated with the bottom portion.

11. The razor blade protection system of claim 1, further including at least one spring connecting the top portion to the bottom portion.

12. The razor blade protection system of claim 11 wherein the top portion, the bottom portion and the at least one spring are a unitary piece formed via injection molding.

13. The razor blade protection system of claim 1 wherein the size of the body is no greater than three times the volume of the head of the razor blade it secures.

14. A razor blade protection system comprising:
a body including a bottom portion and one or more springs, wherein the body is adapted to be secured to the head of a razor blade; and
protective material located within the body such that, when the body is secured to the head of a razor blade, the one or more springs exert a compressive force to maintain the protective material in continuous contact with the cutting edge of the enclosed razor blade.

15. The razor blade protection system of claim 14 wherein the protective material is open cell foam saturated with mineral oil.

16. The razor blade protection system of claim 14 wherein the body and one or more springs are injection molded as one piece.

17. A razor blade protection system comprising:
a body including a top portion and a bottom portion;
one or more springs acting to limit the distance between the top portion and the bottom portion; and
protective material located within the body such that, when the head of a razor blade is secured between the top portion and the bottom portion, the one or more springs force the protective material into continuous contact with the cutting edge of the secured razor blade.

18. The razor blade protection system of claim 17 wherein the one or more springs include at a least one tension spring.

19. The razor blade protection system of claim 17 wherein the one or more springs include at a least one compression spring.

20. The razor blade protection system of claim 17 wherein the one or more springs include at a least one torsion spring.
